(19) United States
(12) Patent Application Publication
(10) Pub. No.: US 2011/0284154 A1
(43) Pub. Date: Nov. 24, 2011

(54) LABEL AUTOMATIC APPLICATION DEVICE AND LABEL AUTOMATIC APPLICATION METHOD

(76) Inventor: Hiroshi Nakamura, Osaka (JP)

(21) Appl. No.: 13/147,410

(22) PCT Filed: Mar. 1, 2010
(86) PCT No.: PCT/JP2010/053207

§ 371 Date: Aug. 2, 2011

(30) Foreign Application Priority Data
Mar. 4, 2009 (JP) 2009-080386

(51) Int. Cl. B32B 38/10; B32B 41/00; B32B 37/02

(52) U.S. Cl. 156/249; 156/362; 156/351

(57) ABSTRACT

The present invention is to provide a label automatic application device and a label automatic application method capable of easily removing a large number of single labels one by one from a label band body formed by coupling the single labels while displacing and overlapping the labels with each other in the longitudinal direction, so as to automatically apply a large amount of labels to application bodies per unit time.

A label band body 8 formed by displacing a little and overlapping many single labels with each other is attached to a label transfer belt conveyor 32. The label transfer belt conveyor 32 to which the label band body 8 is attached and a product transfer belt conveyor 52 for moving application bodies 54 are arranged so that the forward directions thereof are the opposite directions to each other. The air is jetted by an air jet means 38 to a surface onto which a bonding means 5 is coated in a front end 1y of a lead label 1a of the label band body 8. The surface onto which the bonding means 5 is coated in the front end 1y of the lead label 1a is warped in the inversion direction and rolled up outward, so that the application body 54 easily comes into contact with the bonding means 5 of the front end 1y.

### TECHNICAL FIELD

The present invention relates to a label automatic application device and a label automatic application method for successively removing many single labels one by one from a long label band body formed by coupling the labels while displacing a little and overlapping the labels with each other, so as to apply the labels to application bodies.

### BACKGROUND ART

Conventionally, in general, a large number of labels to be applied to application bodies such as products are adhered onto an exfoliate paper and spaced from each other, and wound on a core pipe together with the exfoliate paper. Regarding the labels to be adhered to the exfoliate paper, information such as a price is printed on a surface (one surface) of a label base, and an adhesive is coated onto a back surface (the other surface) of the label base. The adhesive on the back surface of the label and the exfoliate paper are formed of materials so as to be easily detached from each other. In general, the labels are removed from the exfoliate paper one by one by a label automatic application device, and attached to the products (Patent Document 1).

A label application method in the conventional label automatic application device will be described based on FIG. 6. A label roll 74 having a core on which an exfoliate paper 72 with a large number of labels 70 applied thereon is wound is installed to a supply shaft 76, and the exfoliate paper 72 after removal of the labels 70 is installed to a winding shaft 78. The supply shaft 76 and the winding shaft 78 are rotated at the same rotation speed, so that the exfoliate paper 72 with the labels 70 applied thereon is moved. An inversion shaft 80 for inverting the forward direction of the exfoliate paper 72 at an acute angle in the middle of movement of the exfoliate paper 72 is provided, and the forward direction of the exfoliate paper 72 is inverted at an acute angle on the inversion shaft 80. The labels 70 are removed from the exfoliate paper 72 at a position of the inversion shaft 80, and the labels 70 go forward in the direction in which the labels came along. The exfoliate paper 72 from which the labels 70 are removed is then wound on a core pipe on the side of the winding shaft 78.

Meanwhile, application bodies 82 to which the labels are applied are disposed on a product transfer belt conveyor 84 to pass through the vicinity of the inversion shaft 80. The forward direction of the product transfer belt conveyor 84 on which the application bodies 82 are disposed, and the forward direction of the exfoliate paper 72 with the labels 70 applied thereon are set to be the directions toward the same point crossing each other at an acute angle. The labels 70 removed at the position of the inversion shaft 80 are removed from the exfoliate paper 72, and go forward in the direction in which the labels came along and protrude up to a position where the application bodies 82 pass. Each of the application bodies 82 moved in the moving direction of the product transfer belt conveyor 84 comes into contact with an adhesive coating surface of each of the labels 70 removed from the exfoliate paper 72, so that the label 70 is bonded to the application body 82. Since the forward direction of the product transfer belt conveyor 84 and the forward direction of the exfoliate paper 72 with the label 70 applied thereon serve as the directions toward the same point even at an acute angle, the label 70 (whose rear end is bonded to the exfoliate paper 72) is pulled by the application body 82, so that the label 70 is easily removed from the exfoliate paper 72.

When the exfoliate paper to which the labels are to be applied is not used, not only cost reduction due to non-use of the exfoliate paper 72 can be achieved but also generation of carbon dioxide due to incineration of the exfoliate paper 72 can be eliminated. Therefore, the labels without using the exfoliate paper are conventionally provided (Patent Document 2). The labels without using the exfoliate paper are made by forming perforation at a length position for an every single label in a long band shape label main body. When the label is applied to the product, the single label is formed by cutting off from the long band shape label main body at the perforation. In addition, in a case where the perforation is not formed in the long band shape label main body, the single label is formed by cutting at the length position for the single label by a cutting blade.

With the labels of Patent Document 2 without using the exfoliate paper, there are disadvantages that an outer shape of the single label is limited to a square shape, and a label bonding point in the application body is also limited to this square outer shape. In order to overcome the disadvantages, the invention in which without using the exfoliate paper, labels having a free outer shape such as a circular shape, a triangle shape, and an oval shape can be used are provided (Patent Document 3). FIGS. 7 and 8 show the labels of Patent Document 3. According to FIGS. 7 and 8, a label band body 8 is formed by coupling many single (circular, for example) labels 1a, 1b, 1c, 1d, 1e, 1f, 1g . . . while displacing a little and overlapping the labels with each other, and the label band body 8 is wound on a tubular core 7, so that a label roll 6 is formed. In Patent Document 3, a single label is provided with a print portion 3 on which information is printed on one surface of a label base 1, and for example a remover 4 is coated onto the upper side of the print portion 3, and for example an adhesive 5 is coated onto the other surface of the label base 1. The single labels 1a, 1b, 1c, 1d, 1e, 1f, 1g are displaced a little and overlapped with each other (in FIG. 8, a point where the label 1a is overlapped with the label 1b is referred to as the “overlapping part 1x”), and the overlapping part 1x of the remover 4 on the one surface side and the adhesive 5 on the other surface side of the pair of adjacent labels are successively combined, so that the long label band body 8 can be formed. In this Patent Document 3, the exfoliate paper is not used, and the labels having an arbitrary outer shape other than a square shape can be used.

### CITED DOCUMENT LIST

### Patent Document

Patent Document 1: Japanese Patent Laid-Open No. Hei 5-318631
Patent Document 2: Japanese Patent Laid-Open No. 2007-171776
Patent Document 3: Japanese Patent No. 3205804

### SUMMARY OF THE INVENTION

### Problems to be Solved by the Invention

In Patent Document 1, when the label 70 removed from the exfoliate paper 72 is applied to the application body 82, moving time between one label 70 applied to the exfoliate paper 72 and the next label 70 and moving time between one application body 82 and the next application body 82 have to be equal to each other. Since a large number of labels 70 are applied to the exfoliate paper 72 at equal intervals, time adjustment has to be performed with a distance between one application body 82 and the next application body 82. Thus, there is a need for precisely adjusting an interval between the application bodies 82 disposed and moved on the product transfer belt conveyor 84, and cost is required for an adjustment device for this. Further, in a case where the interval between the application bodies 82 loses accuracy, there are fears to cause disadvantages that the label 70 cannot be applied to the application body 82, and the labels 70 are doubly applied to the application body 82.

Further in Patent Document 1, the label 10 and the label 10 are attached to the exfoliate paper 72 while being spaced from each other. Thus, after one label 70 is taken out from the exfoliate paper 72, the exfoliate paper 72 has to be moved by an amount of length serving as the sum of length of one label 70 and the interval between the labels. That is, every time when one label 10 is removed, the exfoliate paper 72 has to be moved by a long distance. Therefore, when a large amount of labels 70 are applied per unit time with using the exfoliate paper 72, the exfoliate paper 72 has to be moved at high speed. Thus, there is a disadvantage that the device becomes complicated and large-sized in order to move the exfoliate paper 72 at high speed, so that cost is increased. Further, the exfoliate paper 72 after removing the labels 70 has to be wound, and there is a need for a space for winding the exfoliate paper 72. Thus, there is a disadvantage that the entire device has to be large-sized.

As another conventional technology, the long label band body formed by coupling many single labels while displacing a little and overlapping the labels with each other is provided (Patent Document 3). In this Patent Document 3, there are advantages that discharge of carbon dioxide can be suppressed by not using the exfoliate paper and furthermore, the shape of the single label can be a shape other than a square shape (such as a circular shape). However, a device and a method for applying a large number of labels to application bodies per unit time with using this label band body were not provided.

The present invention is to solve the conventional problems, and an object thereof is to provide a label automatic application device and a label automatic application method capable of easily removing a large number of single labels one by one from a long label band body formed by displacing a little and continuously overlapping the labels with each other, so as to automatically apply a large amount of labels to application bodies per unit time.

### Means for Solving the Problems

A label automatic application device of the present invention is a device for removing a large number of single labels provided with bonding means on one surfaces one by one from a label band body formed by coupling the single labels while displacing a little and overlapping the labels with each other, so as to apply the removed single labels to application bodies, the label automatic application device having a label transfer belt conveyor to which the label band body is attached, a product transfer belt conveyor for moving the application bodies to which the labels are applied, and an air jet means for jetting the air to the lead label of the label band body, characterized in that the forward direction of the label transfer belt conveyor at a position where the label band body is attached, and the forward direction of the product transfer belt conveyor at a position where the application bodies are disposed are arranged to be the opposite directions to each other, an angle θ made by the forward direction of the label transfer belt conveyor and the forward direction of the product transfer belt conveyor is 5°≦θ≦45°, and the air from the air jet means is jetted to a bonding means side surface of a front end serving as a point other than an overlapping part with the next label in the lead label removed from the label band body, so that the front end is warped in the direction toward the label band body. The present invention is characterized in that the angle θ made by the forward direction of the label transfer belt conveyor and the forward direction of the product transfer belt conveyor is 5°≦θ≦10°. The present invention is characterized in that the label band body and the label transfer belt conveyor are pressed and nipped by a pair of rolls, so that the bonding means side of the label band body is attached to the label transfer belt conveyor. The present invention is characterized in that the labels have one surface on which print is performed and any of overcoat agents including UV varnish, oil-based varnish, and water-based varnish for protecting the print is coated on to the printed surface, and the other surface onto which an olefin based adhesive whose adherence property is revitalized for several times at a predetermined temperature or more is coated. The present invention is characterized by including a label pressing member for pressing the overlapping part with the next label in the lead label of the label band body toward the label transfer belt conveyor, a compression spring for biasing the label pressing member toward the moving direction of the label band body, and a stopper for defining a moving end of the label pressing member toward the moving direction of the label band body. The present invention is characterized by including, in the vicinity of the product transfer belt conveyor on the upstream side of a position where the labels of the label band body are bonded to the application bodies, a first detection sensor arranged on the relatively upstream side along the forward direction of the product transfer belt conveyor, the first detection sensor for detecting the application bodies, and a second detection sensor arranged on the relatively downstream side, the second detection sensor for detecting the application bodies, and characterized in that when the first detection sensor detects passage of the application bodies, the air is jetted from the air jet means, and when the second detection sensor detects passage of the application bodies, jet of the air from the air jet means is stopped, and the label transfer belt conveyor is moved by a predetermined distance. The present invention is characterized by including, in an outside part of the label transfer belt conveyor and in the vicinity of the air jet means, a label position detection sensor for detecting a position of the lead label of the label band body, and characterized in that when the label position detection sensor detects the lead label, movement of the label transfer belt conveyor is stopped. The present invention is characterized by including, in the vicinity of a position where the label band body is attached in the label transfer belt conveyor, a heating means for heating the label band body.

A label automatic application method of the present invention is a method for removing a large number of single labels provided with bonding means on one surfaces one by one from a label band body formed by coupling the single labels while displacing a little and overlapping the labels with each other, so as to apply the removed single labels to application bodies, wherein that the label band body is attached to a label transfer belt conveyor, the forward direction of the label transfer belt conveyor at a position where the label band body is attached, and the forward direction of a product transfer belt conveyor at a position where the application bodies are disposed are arranged to be the opposite directions to each other, an angle θ made by the forward direction of the label transfer belt conveyor and the forward direction of the product transfer belt conveyor is 5°≦θ≦45°, the air is jetted by the air jet means to a bonding means side surface of a front end serving as a point other than an overlapping part with the next label in the lead label removed from the label band body, so that the bonding means side surface of the front end is warped, and the application body comes into contact with the warped bonding means side surface of the front end, so that the label is applied to the application body. The present invention is characterized in that the angle θ made by the forward direction of the label transfer belt conveyor and the forward direction of the product transfer belt conveyor is 5°≦θ≦10°. The present invention is characterized in that the label band body and the label transfer belt conveyor are pressed and nipped by a pair of rolls, so that the bonding means side of the label band body is attached to the label transfer belt conveyor.

The present invention is characterized in that the labels have one surface on which print is performed and any of overcoat agents including UV varnish, oil-based varnish, and water-based varnish for protecting the print is coated on to the printed surface, and the other surface onto which an olefin based adhesive whose adherence property is revitalized for several times at a predetermined temperature or more is coated.

The present invention is characterized in that when the lead label of the label band body is removed from the label band body, the overlapping part with the next label in the lead label is pressed toward the label transfer belt conveyor by a label pressing member.

The present invention is characterized in that after the lead label of the label band body is removed one by one, the label transfer belt conveyor is moved by an amount of length of the front end of the single label, so that the lead label is brought away from the product transfer belt conveyor by the amount of the length of the front end and protrudes outward.

### Effects of the Invention

According to the label automatic application device and the label automatic application method of the present invention, since the forward direction of the product transfer belt conveyor for carrying the application bodies and the forward direction of the label transfer belt conveyor for carrying the label band body are the opposite directions to each other, the lead label bonded to the application body is moved by the application body in a state that the label is rolled up toward the label band body. Thus, the lead label can be easily removed from the label band body (next label). Since the angle θ made by the forward direction of the product transfer belt conveyor and the forward direction of the label transfer belt conveyor is within a range from 5° to 45° (particularly within a range from 5° to 10°), the labels can be easily removed from the label band body. In order to easily remove the labels from the label band body, the forward direction of the product transfer belt conveyor and the forward direction of the label transfer belt conveyor are the opposite directions to each other. Thus, there is a fear that the bonding means side surface of the front end of the lead label does not surely face the application body. Therefore, by the jet of the air from the air jet means, the front end of the lead label is warped with a bonding means coating surface on the outer side, and thereby the lead label protrudes on the side where the application body passes. Thus, the bonding means side surface of the front end of the lead label can be easily bonded to the application body.

In the present invention, the long label band body formed by coupling a large number of single labels while displacing a little is used. Thus, a moving distance of the label band body after application of one label to the application body is length of the front end of the label (length obtained by subtracting length of the overlapping part of the label from the entire length of the label). Therefore, the moving distance of the label in the present invention can be shortened in comparison to a moving distance of a conventional example of using an exfoliate paper with a large number of labels applied thereon. As a result, since the labels are easily removed from the label band body, and the moving distance of the label is shortened in the present invention, a number of labels bonded to the application bodies per unit time can be dramatically increased in comparison to the conventional example, so that economic efficiency can be improved.

Since the bonding means is exposed on the entire area of the one surface of the label band body, the label transfer belt conveyor and the label band body are pressed and nipped with using a pair of rollers (a roulette drive roller and a nip roll), so that the label band body can be attached (press-fitted or bonded) to the label transfer belt conveyor with weak force.

Since the label band body is attached to the transfer belt conveyor, the label band body can be moved even in a state that the label band body stands in the vertical direction or in a state that the label band body is attached on the lower side of the transfer belt conveyor, so that the labels can be applied at any positions on upper and lower surfaces of the application bodies.

When the lead label is removed from the label band body, the overlapping part of the lead label of the label band body with the next label is pressed by the label pressing member. By this label pressing member, resistance at the time of removal from the label band body is generated in the lead label, so that together with the lead label, the next label is also pressed toward the label transfer belt conveyor by the label pressing member. As a result, generation of a disadvantage that when the lead label is removed from the label band body, the next label is removed together can be prevented.

### BRIEF DESCRIPTION OF THE DRAWINGS

FIG. 1 A plan view showing one embodiment of a label automatic application device according to the present invention.

FIG. 2 A side view of major parts in the A direction of FIG. 1.

FIG. 3 A plan view showing a positional relationship between the major parts of the label automatic application device according to the present invention and a product transfer belt conveyor.

FIG. 4 A perspective view of the major parts of the label automatic application device according to the present invention.

FIG. 5 A plan view showing a positional relationship between a position of an application body and a lead label of a label band body.

FIG. 6 A plan view showing an application state of a label and an application body in a conventional label automatic application device.

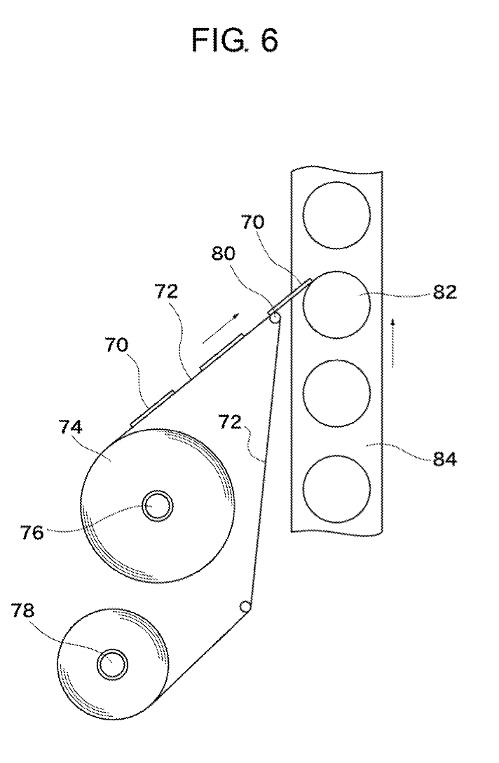

FIG. 7 A perspective view showing the label band body formed by coupling a large number of single labels, and a label roll on which the label band body is wound.

FIG. 8 A side view showing a bonding state of a pair of single labels shown in FIG. 7.

### DESCRIPTION OF REFERENCE NUMERALS

1a, 1b, 1c, 1d, 1e, 1f, 1g: Single label
1x: Overlapping part
1y: Front end
8: Label band body
22: Roulette drive roller
22: Stepping motor
26: Nip roller
28: Inversion shaft
32: Label transfer belt conveyor
36: Heating means
38: Jet means air
40: Label position detection sensor
42: Compression spring
44: Support member
46: Movable member
50: Label pressing member
52: Product transfer belt conveyor
54: Application body
58: First detection sensor
60: Second detection sensor

### MODES FOR CARRYING OUT THE INVENTION

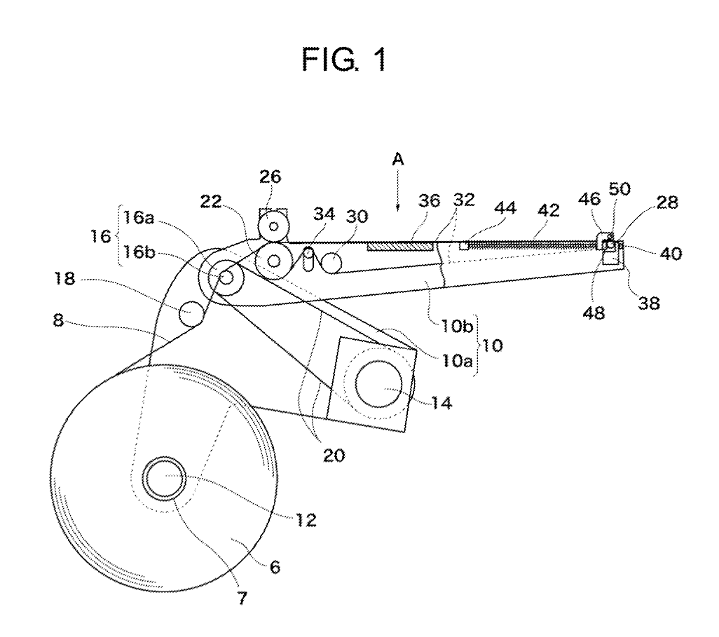

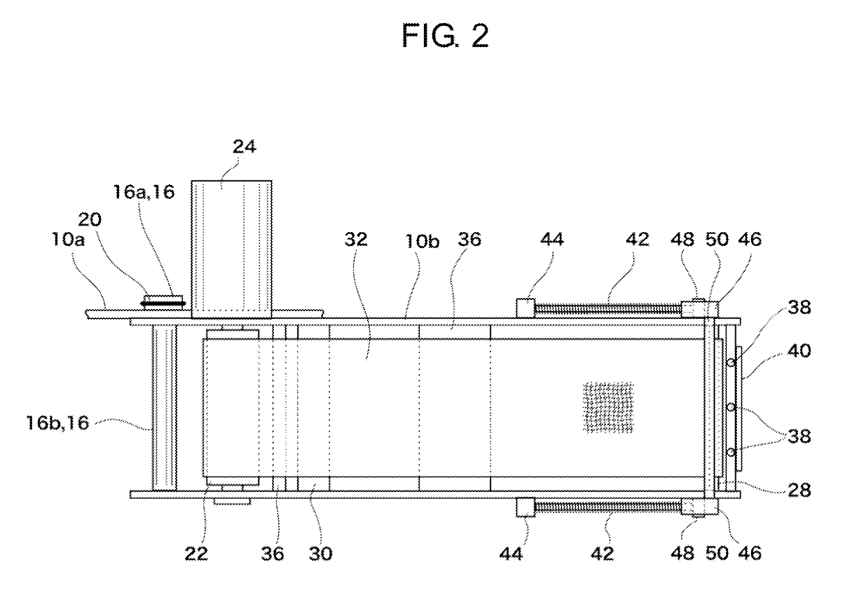

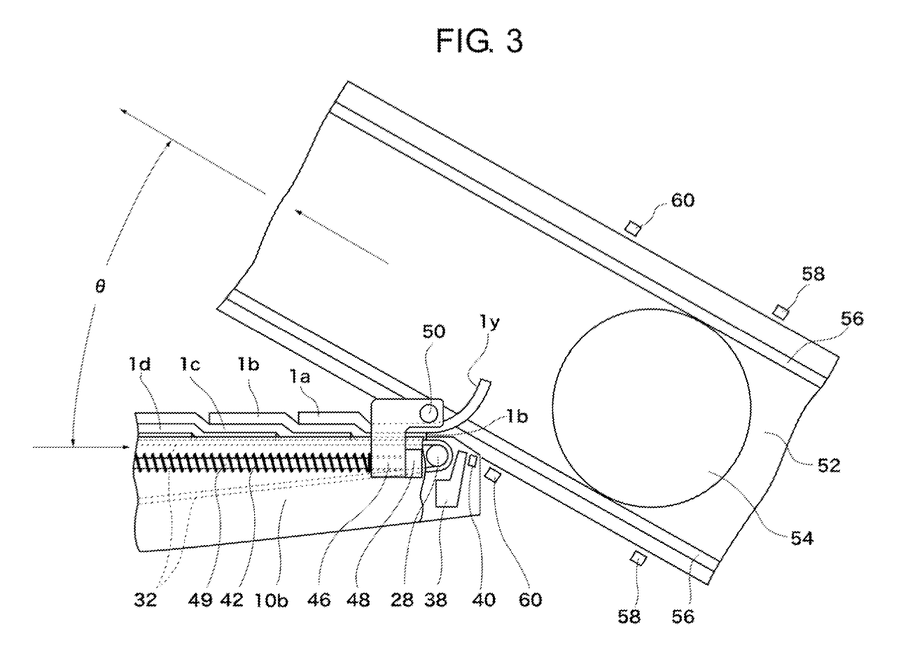

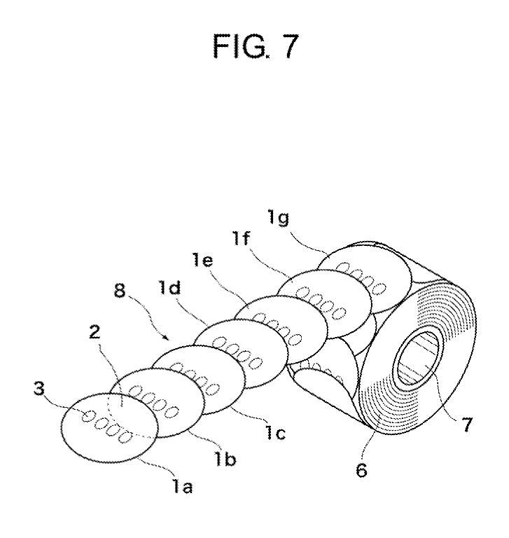

Next, the present invention will be described based on the drawings. FIG. 1 is a plan view showing one embodiment of a label automatic application device according to the present invention, FIG. 2 is a side view of major parts in the A direction of FIG. 1, and FIG. 3 is a plan view showing a positional relationship between the major parts of the label automatic application device according to the present invention and a product transfer belt conveyor. The label automatic application device according to the present invention is a device for removing a large number of single labels one by one from a long label band body formed by coupling the single labels while displacing a little and overlapping the labels with each other, so as to apply the labels to application bodies. The label automatic application device according to the present invention has a housing 10 including a first housing 10a and a second housing 10b fixed to each other. A shaft 12 is fixed to the first housing 10a, and a label roll 6 (having the same shape as FIG. 7) on which a label band body 8 is wound is rotatably retained on the shaft 12.

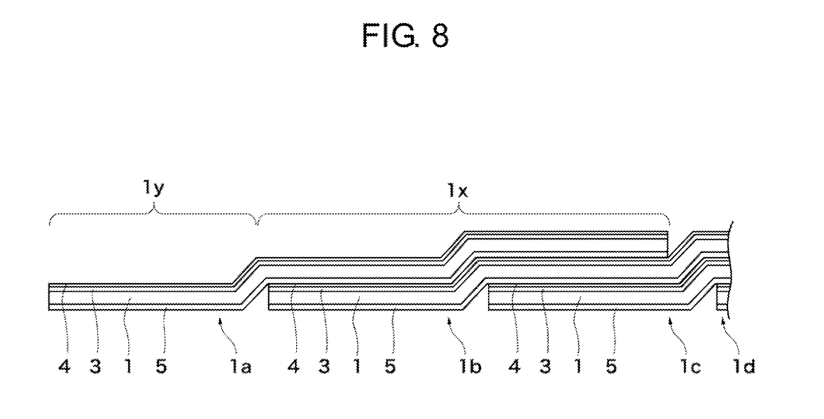

The labels used in the present invention do not require use of an exfoliate paper. The label band body 8 of the present invention is formed by coupling a large number of single (circular, for example) labels 1a, 1b, 1c, 1d, 1e, 1f, 1g . . . while displacing a little and overlapping the labels with each other as well as the label band body shown in FIG. 7. In the label roll 6, the label band body 8 is wound on a tubular core. In Cited Document 1, in the single label, a remover 4 is coated onto one surface of a label base 1, and an adhesive 5 serving as a bonding means is coated onto the other surface of the label base 1. This label shown in Cited Document 1 may be used in the present invention. However, as the single labels 1a, 1b, 1c, 1d, 1e, 1f, 1g . . . used in the present invention, it is desirable to use labels (thermosensitive labels) in which print is performed on the upper side of the label base, any of overcoat agents including UV varnish, oil-based varnish, and water-based varnish for protecting the print is coated onto the printed surface, and an olefin based adhesive whose adherence property is revitalized for several times at a predetermined temperature or more, the olefin based adhesive serving as a bonding means is coated onto the lower side of the label base. In the thermosensitive labels, since the overcoat agent is used for one surface, and the olefin based adhesive is used for the other surface, pseudo-bonding and detachment between the overcoat agent and the olefin base adhesive can be easily performed by heating. Furthermore, without damaging the overcoat agent at the time of the detachment, the pseudo-bonding and the detachment can be easily performed for several times. Further, regarding the thermosensitive labels, the single thermosensitive label can be formed into an arbitrary shape required for the application body such as a circular shape, an oval shape, a triangle shape, and a square shape. Moreover, the olefin based adhesive can be lightly bonded to an object (such as a belt conveyor) even by heating or by pressurizing. Length of an overlapping part (1x in FIG. 8) where a pair of labels is overlapped with each other in the longitudinal direction is desirably ⅔ or more of length of the single label in the longitudinal direction.

A motor 14 is fixed to the housing 10a, and further, a first roulette idle roller 16 and a second roulette idle roller 18 are rotatably attached. The first roulette idle roller 16 is formed by integrating a large-diameter roller portion 16a and a small-diameter roller portion 16b. The large-diameter roller portion of the first roulette idle roller 16 and the motor 14 communicate with each other by a drive belt 20. By drive of the motor 14, the first roulette idle roller 16 is rotated via the drive belt 20. The label band body 8 pulled out from the label roll 6 comes into contact with the second roulette idle roller 18 and the small-diameter roller portion of the first roulette idle roller 16 in order. The first roulette idle roller 16 is rotated by the drive of the motor 14, and by the rotation force thereof, the label band body 8 is moved in the rotation direction of the first roulette idle roller 16.

The small-diameter roller portion 16b of the first roulette idle roller 16, a roulette drive roller 22, a stepping motor 24 (FIG. 2) for intermittently driving the roulette drive roller 22, a nip roller 26, a roller 28 for inverting a belt, and an idle roller 30 are attached to the second housing 10b. A label transfer belt conveyor 32 is looped over the roulette drive roller 22 and the roller 28 and the idle roller 30. Further, a tension roller 34 for giving tensile force to the label transfer belt conveyor 32 is movably provided in the housing 10b. The stepping motor 24 intermittently moves the label transfer belt conveyor 32 to which the label band body 8 is attached by an amount of length of a front end 1y (FIG. 8) serving as a point other than the overlapping part 1x in the single label.

In an area surrounded by the label transfer belt conveyor 32, a heating means 36 is provided in the vicinity of a proper position of the label band body 8 attached to the label transfer belt conveyor 32. This heating means 36 is to heat the label band body 8 attached to the label transfer belt conveyor 32. When the labels of the label band body 8 have the one surfaces with the overcoat agent and the other surfaces with the olefin based adhesive, adhesive force is revitalized and a detaching property is increased in the point where the labels are overlapped with each other by heating the labels.

The label band body 8 passing through the first roulette idle 14 is pressed and nipped by the roulette drive roller 22 and the nip roller 26. The nip roller 26 is desirably made of rubber or soft synthetic resin, and presses the label band body 8 toward the roulette drive roller 22 (the label transfer belt conveyor 32) with proper force by a pressing force adjusting means (not shown). Pressing force to the label band body 8 by the nip roller 26 is adjusted according to size of the labels or a type of the labels. The label band body 8 is arranged so that the bonding means 5 side faces the label transfer belt conveyor 32. Thereby, when passing through between the roulette drive roller 22 and the nip roller 26, the label band body 8 is press-fitted (bonded or attached) to the label transfer belt conveyor 32 with weak force by pressing and nipping by the pair of rollers.

Since FIGS. 1 and 3 are plan views, the label band body 8 and the label transfer belt conveyor 32 stand in the vertical direction. Even in a state that such a label band body 8 and the label transfer belt conveyor 32 stand in the vertical direction or in a case where the label band body 8 is attached downward to the label transfer belt conveyor 32, the label band body 8 is press-fitted (bonded or attached) to the label transfer belt conveyor 32 with weak force so that the label band body 8 is not brought away from the label transfer belt conveyor 32. A material of the bonding means 5 to be coated onto the labels and a material of the label transfer belt conveyor 32 are selected so that the label band body 8 can be bonded to or removed from the label transfer belt conveyor 32 with proper force. The olefin based adhesive is desirable as the material of the bonding means 5 to be coated onto the labels.

The roller 28 for inverting the belt conveyor is provided in an end in the forward direction of the label transfer belt conveyor 32. The label transfer belt conveyor 32 is set so that the forward direction thereof is inverted at an angle close to 180 degrees at a position of the roller 28. At the position where the forward direction of the label transfer belt conveyor 32 is inverted at the angle close to 180 degrees, the front end 1y of the lead label 1a of the label band body 8 is removed from the label transfer belt conveyor 32, and the front end 1y of the lead label 1a protrudes and goes forward in the same direction as the forward direction of the label transfer belt conveyor 32 up to the position of the roller 28. In the lead label 1a, the overlapping part 1x (FIG. 8) serving as the point other than the front end 1y remains bonded to the next label 1b.

An air jet means 38 having an air jet nozzle is provided on the outer side of the label transfer belt conveyor 32 (outer side of the position of the roller 28), and a label position detection sensor 40 is provided on the outer side of the air jet means 38. The air jet means 38 is to jet the air toward the front end 1y (bonding means 5 side surface) away from the label transfer belt conveyor 32 in the lead label 1a. The label position detection sensor 40 is to detect whether or not the front end 1y of the lead label 1a is brought away from the label transfer belt conveyor 32 and reaches to a predetermined position (stand-by position).

As shown in FIG. 2, on the two parallel outer sides of the second housing 10b, support members 44 supporting one ends of compression springs 42 are respectively fixed. Movable members 46 are respectively fixed to the other ends of the compression springs 42. Stoppers 48 to be abutted with the movable members 46 for defining ends in the moving direction of the movable members 46 toward one side are further fixed to the second housing 10b. Rods 49 are fixed to the support members 44 and the stoppers 48 while passing through the movable members 46. The movable members 46 are biased in the direction in which the movable members always come into contact with the stoppers 48 by the compression springs 42. A rod shape label pressing member 50 having a circular section is fixed over the two movable members 46. The label pressing member 50 is desirably a roller rotated relative to the movable members 46.

As shown in FIG. 3 (plan view), a product transfer belt conveyor 52 is arranged on the lower side of the device shown in FIG. 1. Application bodies 54 serving as products to which the labels are applied are disposed on the product transfer belt conveyor 52, and moved in the predetermined direction by the product transfer belt conveyor 52. On the upper side of the product transfer belt conveyor 52, guides 56 for moving the application bodies 54 in the same direction as the moving direction of the product transfer belt conveyor 52 are provided.

On the both sides or on one side of the vicinity of the product transfer belt conveyor 52, a first sensor 58 on the relatively upstream side and a second sensor 60 on the relative downstream side are provided in order toward the forward direction of the product transfer belt conveyor 52. The label is applied to the application body 54 at a position on the downstream side of the second sensor 60. The first sensor 58 actuates the air jet means 38 at the time of detecting the application body 54, and jets the air to the front end 1y of the label 1a at a lead position of the label band body 8. The air from the air jet means 38 is jetted to the bonding means 5 side surface of the front end 1y of the lead label 1a so as to warp the front end 1y toward the label band body 8. As a result, the bonding means 5 side surface of the front end 1y of the lead label 1a is warped outward in an arc shape.

In the present invention, the forward direction of the product transfer belt conveyor 52 on which the application bodies 54 are disposed and the forward direction of the label transfer belt conveyor 32 to which the label band body 8 is attached are the opposite directions. In FIG. 3, when an angle made by the forward direction of the product transfer belt conveyor 52 and the forward direction of the belt conveyor 34 is θ, the angle θ is within a range from 5° to 45° (5°≦θ≦45°). The angle θ is particularly desirably within a range from 5° to 10° (5°≦θ≦10°). In a period when the angle θ reaches from 0° to 5°, there is a fear that the forward directions become the opposite directions on the substantially identical straight line, and the application body 54 collides with part of the present device. Thus, this angle cannot be adopted. Alternatively, in a case where the angle θ exceeds 45°, the lead label 1a to be detached from the label band body 8 is not easily removed from the next label 1b. Thus, this angle cannot be adopted. Since the label to be detached can be easily removed from the next label, the range of the angle θ from 5° to 10° is particularly desirable.

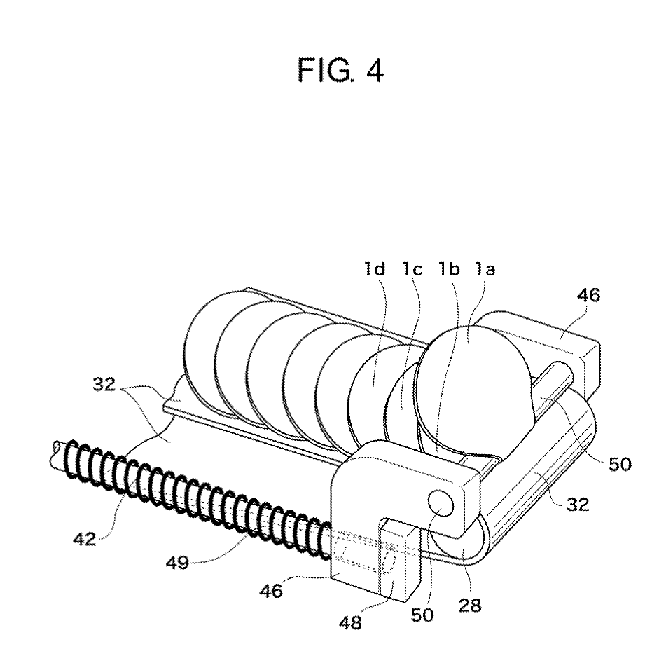

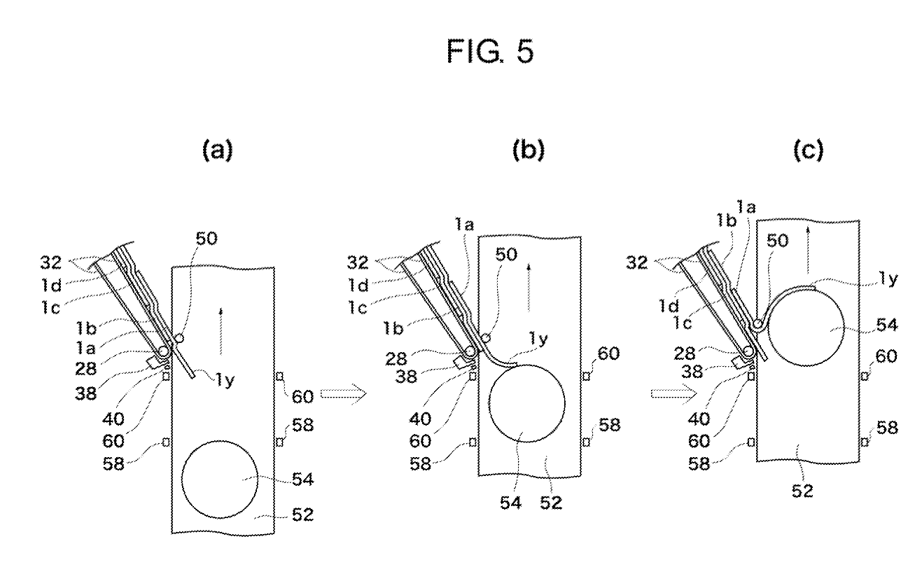

Next, operations of applying the label 1a to the application body 54 with using the present invention will be described based on FIGS. 1 to 5. The label band body 8 pulled out from the label roll 6 shown in FIG. 1 comes into contact with the second roulette idle roller 18 and the first roulette idle roller 16 in this order, and then is nipped by the roulette drive roller 22 and the nip roller 26. By the pressing force of the nip roller 26 toward the label transfer belt conveyor 32 (roulette drive roller 22), a bonding means 5 side surface of the label band body 8 is bonded to the label transfer belt conveyor 32 with weak force. The label band body 8 and the label transfer belt conveyor 32 are intermittently moved by the roulette drive roller 22 (stepping motor 24). When the front end 1y of the lead label 1a of the label band body 8 bonded to the label transfer belt conveyor 32 is brought away from the label transfer belt conveyor 32 and protrudes to a predetermined position, the label position detection sensor 40 detects the front end 1y of the label 1a and stops the drive of the motor 14, and also stops drive of the stepping motor 24. That is, feeding of the label band body 8 toward the label transfer belt conveyor 32 is stopped, and movement of the label transfer belt conveyor 32 is also stopped. A state that the front end 1y of the lead label 1a is brought away from the label transfer belt conveyor 32 and temporarily stopped is the “stand-by state”. In this stand-by state, the front end 1y of the lead label 1a protrudes to a position where the application body 54 moved by the product transfer belt conveyor 52 comes into contact. In this state, the front end 1y of the next label 1b is in a state (FIG. 5(a)) that the front end is in contact with the product transfer belt conveyor 52.

When the product transfer belt conveyor 52 and the application body 54 are moved in the forward direction (arrow direction) from this stand-by state in FIG. 5(a), and the first sensor 58 detects that the application body 54 passes through a predetermined position, the air jet means 38 is actuated, and the air is jetted from the air jet means 38 to the front end 1y of the lead label 1a. By the jetted air, the front end 1y of the lead label 1a is warped from a straight shape (FIG. 5(a)) into an arc shape, and the bonding means 5 of the front end 1y of the label 1a becomes a state that the application body 54 can sufficiently come into contact (FIG. 3). Since the forward direction of the product transfer belt conveyor 52 and the forward direction of the label transfer belt conveyor 32 to which the label band body 8 is attached are the opposite directions (the angle θ made by the forward directions is particularly desirably 5°≦θ≦45°), the arc shape front end 1y protrudes toward the application body 54 more than the straight shape front end 1y.

After that, when the product transfer belt conveyor 52 and the application body 54 are further moved in the forward direction, and the second sensor 60 detects that the application body 54 reaches to a predetermined position, jet of the air from the air jet means 38 is stopped, and the stepping motor 24 is actuated so as to move the label transfer belt conveyor 32. Regarding the movement of the label transfer belt conveyor 32, the overlapping part 1x of the first label 1a and the second label 1b is moved toward the product transfer belt conveyor 52, and a point serving as the front end 1y of the second label 1b is removed from the label transfer belt conveyor 32 and protrudes toward the product transfer belt conveyor 52. FIGS. 5(b) and 5(c) show a progression that the front end 1y of the second label 1b is removed from the label transfer belt conveyor 32 and protrudes toward the product transfer belt conveyor 52.

FIG. 5(b) shows a state that the product transfer belt conveyor 52 and the application body 54 are slightly moved from the state in FIG. 3. Slightly before reaching to the state in FIG. 5(b) from the state in FIG. 3, the jet of the air from the air jet means 38 is stopped. When the jet of the air from the air jet means 38 is stopped, the front end 1y of the label 1a warped into an arc shape attempts to return into a straight shape. However, before the front end returns into a straight shape, the application body 54 is moved in the forward direction. Thus, the application body 54 comes into contact with the bonding means 5 of the front end 1y of the label 1a remaining in an arc shape, and the front end 1y of the label 1a is bonded to the application body 54. Since the label transfer belt conveyor 32 moves the label band body 8 toward the product transfer belt conveyor 52, the label 1a is fed toward the product transfer belt conveyor 52 together with movement of the application body 54. At the same time, since the application body 54 is moved while being bonded to the front end 1y of the label 1a, the overlapping part 1x of the label 1a starts being removed from the label 1b and changes from the state in FIG. 5(b) to a state in FIG. 5(c). After that, the application body 54 is moved, so that the label 1a is removed from the label 1b and completely applied to the application body 54.

The overlapping part 1x of the label 1a temporarily bonded to the label 1b is pressed toward the label transfer belt conveyor 32 by the label pressing member 50. Even when force is imposed on the label 1a in the direction in which the overlapping part 1x of the label 1a bonded to the label 1b is removed from the label 1b, the label pressing member 50 presses not only the label 1a but also the label 1b and the label 1c toward the label transfer belt conveyor 32. Thus, even during the time when the overlapping part 1x of the label 1a is gradually removed from the label 1b, the force acts in the direction in which the label pressing member 50 presses the label 1b and the label 1c toward the label transfer belt conveyor 32. Thereby, when the label 1a is removed from the label 1b, a disadvantage that the label 1b and the label 1c are removed from the label band body 8 together with the label 1a can be eliminated by the label pressing member 50.

As the product transfer belt conveyor 52 and the application body 54 are moved and the overlapping part 1x of the label 1a is removed from the label 1b, the label 1a is rolled up toward the label band body 8, and the label pressing member 50 is moved toward the support members 44 against the compression springs 48 by the rolled-up label 1a. After that, when the label 1a is completely brought away from the label 1b, resistance force of the label 1a against the label pressing member 50 disappears. Thus, by spring force of the compression springs 48, the movable members 46 retaining the label pressing member 50 are returned to positions to collide with the stoppers 48.

When the product transfer belt conveyor 52 and the application body 54 are further moved in the forward direction from the state in FIG. 5(c), the label 1a is completely brought away from the label 1b and bonded to the application body 54. During the time when the front end 1y comes into contact with the application body 54 and then the label 1a is brought away from the label 1b and completely bonded to the application body 54, the next label 1b is moved together with the label transfer belt conveyor 32, and the front end 1y of the next label 1b protrudes outward from the label transfer belt conveyor 32. When the label position detection sensor 40 detects the front end 1y of the next label 1b, the movement of the label transfer belt conveyor 32 is stopped, and the device becomes the stand-by state. This stand-by state is the state in FIG. 5(a). The label 1a is replaced by the label 1b, the label 1b is replaced by the label 1c, and the labels are replaced in order.

As described above, in the present invention, when the lead label 1a of the label band body 8 is bonded to the application body 54, the air from the air jet means 38 is jetted to the bonding means 5 side surface of the front end 1y of the lead label 1a, so that the front end 1y of the lead label 1a is warped onto the opposite side. The bonding means 5 side surface of the front end 1y of the lead label 1a of the label band body 8 is warped outward into an arc shape, so that a position of the bonding means 5 side surface of the front end 1y of the then-straight shape label 1a (position of the front end 1y of the label 1a in FIG. 5(a)) can protrude toward the product transfer belt conveyor 52 (position of the front end 1y of the label 1a in FIG. 5(b)). Thereby, the bonding means 5 of the front end 1y of the lead label 1a can be easily bonded to the application body 54.

Further in the present invention, the application body 54 is moved in the opposite direction to the forward direction of the label band body 8, so that force of rolling up the label 1a warped toward the label band body 8 in the opposite direction to the forward direction of the label band body 8 is imposed by the application body 54. Thus, the lead label 1a of the label band body 8 can be easily removed from the next label 1b. In the label band body 8 formed by coupling many single labels while overlapping the labels with each other in the longitudinal direction, the lead label 1a is removed while being rolled up toward the next label 1b and the following label 1c, so that the lead label 1a can be easily removed from the label band body 8. When the angle θ made by the forward direction of the product transfer belt conveyor 52 and the forward direction of the belt conveyor 34 is a particularly small angle (5°≦θ≦10°), the lead label 1a is easily removed from the label band body 8, so that a large number of labels can be applied to the application bodies 54 per unit time.

Further, in a conventional example in which the labels are applied onto the exfoliate paper, a distance of moving the exfoliate paper at the time of applying one label is a length distance serving as the sum of length of one label and a gap between the labels. Meanwhile, in the present invention, a distance of moving the label band body 8 at the time of applying one label is only length of the front end 1y of the lead label 1a (about 5 to 10 mm in general). In such a way, in the present invention, the lead label 1a of the label band body 8 can be easily removed from the label band body 8, and furthermore, the moving distance of the label band body 8 for every time when one label is applied can be shortened. Thus, a number of labels bonded to the application bodies 54 per unit time can be dramatically increased in comparison to the conventional example, so that economic efficiency can be improved.

1. A label automatic application device for removing a large number of single labels provided with bonding means on one surfaces one by one from a label band body formed by coupling the single labels while displacing a little and overlapping the labels with each other, so as to apply the removed single labels to application bodies, the label automatic application device having:
a label transfer belt conveyor to which the label band body is attached;
a product transfer belt conveyor for moving the application bodies to which the labels are applied; and
an air jet means for jetting the air to the lead label of the label band body, wherein
the forward direction of the label transfer belt conveyor at a position where the label band body is attached, and the forward direction of the product transfer belt conveyor at a position where the application bodies are disposed are arranged to be the opposite directions to each other,
an angle θ made by the forward direction of the label transfer belt conveyor and the forward direction of the product transfer belt conveyor is 5°≦θ≦45°, and
the air from the air jet means is jetted to a bonding means side surface of a front end serving as a point other than an overlapping part with the next label in the lead label removed from the label band body, so that the front end is warped in the direction toward the label band body.

2. The label automatic application device according to claim 1, wherein
the angle θ made by the forward direction of the label transfer belt conveyor and the forward direction of the product transfer belt conveyor is 5°≦θ≦10°.

3. The label automatic application device according to claim 1, wherein
the label band body and the label transfer belt conveyor are pressed and nipped by a pair of rolls, so that the bonding means side of the label band body is attached to the label transfer belt conveyor.

4. The label automatic application device according to claim 1, wherein
the labels have one surface on which print is performed and any of overcoat agents including UV varnish, oil-based varnish, and water-based varnish for protecting the print is coated on to the printed surface, and the other surface onto which an olefin based adhesive whose adherence property is revitalized for several times at a predetermined temperature or more is coated.

5. The label automatic application device according to claim 1, comprising:
a label pressing member for pressing the overlapping part with the next label in the lead label of the label band body toward the label transfer belt conveyor;
a compression spring for biasing the label pressing member toward the moving direction of the label band body; and
a stopper for defining an end in the moving direction of the label pressing member by the compression spring.

6. The label automatic application device according to claim 1, comprising, in the vicinity of the product transfer belt conveyor on the upstream side of a position where the labels of the label band body are bonded to the application bodies:
a first detection sensor arranged on the relatively upstream side along the forward direction of the product transfer belt conveyor, the first detection sensor for detecting the application bodies; and
a second detection sensor arranged on the relatively downstream side, the second detection sensor for detecting the application bodies, wherein
when the first detection sensor detects passage of the application bodies, the air is jetted from the air jet means, and
when the second detection sensor detects passage of the application bodies, jet of the air from the air jet means is stopped, and the label transfer belt conveyor is moved by a predetermined distance.

7. The label automatic application device according to claim 1, comprising, in an outside part of the label transfer belt conveyor and in the vicinity of the air jet means:
a label position detection sensor for detecting a position of the lead label of the label band body, wherein
when the label position detection sensor detects the lead label, movement of the label transfer belt conveyor is stopped.

8. The label automatic application device according to claim 1, comprising, in the vicinity of a position where the label band body is attached in the label transfer belt conveyor:
a heating means for heating the label band body.

9. A label automatic application method for removing a large number of single labels provided with bonding means on one surfaces one by one from a label band body formed by coupling the single labels while displacing a little and overlapping the labels with each other, so as to apply the removed single labels to application bodies, wherein
the label band body is attached to a label transfer belt conveyor,
the forward direction of the label transfer belt conveyor at a position where the label band body is attached, and the forward direction of a product transfer belt conveyor at a position where the application bodies are disposed are arranged to be the opposite directions to each other,
an angle θ made by the forward direction of the label transfer belt conveyor and the forward direction of the product transfer belt conveyor is 5°≦θ≦45°,
the air is jetted by the air jet means to a bonding means side surface of a front end serving as a point other than an overlapping part with the next label in the lead label removed from the label band body, so that the bonding means side surface of the front end is warped, and
the application body comes into contact with the warped bonding means side surface of the front end, so that the label is applied to the application body.

10. The label automatic application method according to claim 9, wherein
the angle θ made by the forward direction of the label transfer belt conveyor and the forward direction of the product transfer belt conveyor is 5°≦θ≦10°.

11. The label automatic application method according to claim 9, wherein
the label band body and the label transfer belt conveyor are pressed and nipped by a pair of rolls, so that the bonding means side of the label band body is attached to the label transfer belt conveyor.

12. The label automatic application method according to claim 9, wherein
the labels have one surface on which print is performed and any of overcoat agents including UV varnish, oil-based varnish, and water-based varnish for protecting the print is coated on to the printed surface, and the other surface onto which an olefin based adhesive whose adherence property is revitalized for several times at a predetermined temperature or more is coated.

13. The label automatic application method according to claim 9, wherein
when the lead label of the label band body is removed from the label band body, the overlapping part with the next label in the lead label is pressed toward the label transfer belt conveyor by a label pressing member.

14. The label automatic application method according to claim 9, wherein
after the lead label of the label band body is removed one by one, the label transfer belt conveyor is moved by an amount of length of the front end of the single label, so that the lead label is brought away from the product transfer belt conveyor by the amount of the length of the front end and protrudes outward.
